(19) United States
(12) Patent Application Publication
(10) Pub. No.: US 2024/0242206 A1
(43) Pub. Date: Jul. 18, 2024

(54) USER VERIFICATION WITH DIGITAL TAG

(71) Applicant: Visa international Service Association, San Francisco, CA (US)

(72) Inventors: Micael de Torres Gomes, Alameda, CA (US); Jarkko Oskari Sevanto, Barkeley, CA (US); Vikram Modi, Lafayette, CA (US)

(73) Assignee: Visa international Service Association, San Francisco, CA (US)

(21) Appl. No.: 18/559,788

(22) PCT Filed: May 25, 2022
(86) PCT No.: PCT/US2022/030891

§ 371 Date: Nov. 8, 2023

Related U.S. Application Data
(60) Provisional application No. 63/193,710, filed on May 27, 2021.

(51) Int. Cl. G06Q 20/38

(52) U.S. Cl. CPC G06Q 20/38215

(57) ABSTRACT

A method includes receiving, from a first transfer application on a first user device associated with a first user, a transfer request message for a transfer transaction. The transfer request message comprises a digital tag associated with a second user and a transaction amount. The method includes generating and transmitting a code to a second transfer application on a second user device, and receiving a confirmation message that the second user wants to conduct the transfer transaction and is sharing the code with the first user. The method includes transmitting the code to the first transfer application on the first user device. The first transfer application compares the code received from the digital tag computer with the code received from the second user and initiates the transfer transaction if the code received from the digital tag computer with the code received from the second user match.

### CROSS-REFERENCES TO RELATED APPLICATIONS

This application is a PCT Application claiming priority to U.S. 63/193,710, filed on May 27, 2021, which is herein incorporated by reference in its entirety.

### BACKGROUND

Many transactions are completed by exchanging a primary account number between a first user and a second user. Often, it is difficult to remember or correctly input the primary account number (e.g., a set of sixteen alphanumeric characters which links to an account) into a transfer application which facilitates transaction. Additionally, there may be privacy concerns with a first user learning the primary account number of a second user.

Many transfer applications allow users of the application to easily transact with other users of the same application. Such an application may use an alias (e.g., an email address, a phone number, etc.) to facilitate a transaction over a primary account number. The use of an alias allows for users to easily direct transactions to users of the same application. However, the specific alias that is used may not be used by all transfer applications. Furthermore, email addresses and phone numbers are increasingly considered sensitive personal data and users may not be comfortable sharing those with people they don't know that well.

Another issue to be addressed is ensuring that the recipient of a payment is the intended recipient when the recipient or payee uses one transfer application (e.g., a first wallet application) on their mobile device, and the sender or payer uses a different transfer application (e.g., a different wallet application) on their mobile device.

Embodiments of the disclosure address this problem and other problems individually and collectively.

### SUMMARY

One embodiment includes a method. The method comprises: receiving, by a digital tag computer from a first transfer application on a first user device associated with a first user, a transfer request message for a transfer transaction, the transfer request message comprising a digital tag associated with a second user and a transaction amount; responsive to receiving the transfer request message, generating, by the digital tag computer, a code; transmitting, by the digital tag computer, the code to a second transfer application associated with the second user, the second transfer application on a second user device; receiving, by the digital tag computer, a confirmation message that the second user wants to conduct the transfer transaction and is sharing the code with the first user; and responsive to receiving the confirmation message, transmitting, by the digital tag computer, the code to the first transfer application on the first user device, wherein first transfer application on the first user device compares the code received from the digital tag computer with the code received from the second user, and initiates the transfer transaction if the code received from the digital tag computer with the code received from the second user match.

Another embodiment includes a digital tag computer comprising: a processor; and a non-transitory computer readable medium, the non-transitory computer readable medium comprising code, executable by the processor to perform operations comprising: receiving, from a first transfer application on a first user device associated with a first user, a transfer request message for a transfer transaction, the transfer request message comprising a digital tag associated with a second user and a transaction amount; responsive to receiving the transfer request message, generating a code; transmitting the code to a second transfer application associated with the second user, the second transfer application on a second user device; receiving a confirmation message that the second user wants to conduct the transfer transaction and is sharing the code with the first user; and responsive to receiving the confirmation message, transmitting the code to the first transfer application on the first user device, wherein first transfer application on the first user device compares the code received from the digital tag computer with the code received from the second user, and initiates the transfer transaction if the code received from the digital tag computer with the code received from the second user match.

Yet another embodiment includes a method. The method comprises: entering, into a first transfer application on a first user device, a digital tag associated with a second user and a transaction amount; transmitting, by the first transfer application to a digital tag computer, the digital tag associated with the second user and the transaction amount, wherein the digital tag computer generates a code and sends the code to a second transfer application on a second user device associated with the second user; receiving, by the first transfer application from the digital tag computer, the code; receiving, by the first transfer application, the code from the second user; determining that the code received from the digital tag computer and the code received from the second user match; and responsive to the match, processing a transfer of the transaction amount to the second transfer application associated with the second user.

This and other embodiments are described in detail below.

### BRIEF DESCRIPTION OF THE DRAWINGS

FIG. 1 shows a flow diagram of a user requesting issuance of a digital tag from an authorizing entity.

FIG. 2 shows an example flow for requesting issuance of a digital tag linked to a virtual credential from a transfer application server.

FIG. 3 shows a flow diagram and system illustrating a method for online verification.

FIG. 4 shows a flow diagram and system illustrating a method for verification in a face-to-face transaction.

FIG. 5 shows an example flow for a transaction between a first user and a second user using a digital tag linked to a virtual credential.

FIG. 6 shows a block diagram of a user device.

FIG. 7 shows a block diagram of a digital tag computer.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be any suitable device that a user can interact with (e.g., a payment card or mobile phone). User devices may be in any suitable form. Some examples of user devices include cards (e.g., payment cards such as credit, debit, or prepaid cards) with magnetic stripes or contactless elements (e.g., including contactless chips and antennas), cellular phones, PDAs, personal computers (PCs), tablet computers, and the like. In some embodiments, where a user device is a mobile device, the mobile device may include a display, a memory, a processor, a computer-readable medium, and any other suitable component.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may be a transfer application.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “digital tag” may be a unique identifier used to facilitate transfers. A digital tag may be a set of alphanumeric characters to be associated with a user. The digital tag may be a payment tag that point to a virtual credential issued by an authorizing entity and linked to an account registered with a peer-to-peer application. The virtual credential may be in the form of a real payment credential, but unlike a real payment credential, it cannot be used to independently conduct payment transactions.

A “transfer application” (e.g., a peer-to-peer application), accessed (e.g., installed, accessed via a web browser, etc.) by a user operating a user device, may allow users of the application to send, receive, or request transfers from other users of the application. For example, a first user may use a transfer application on their user device to generate a transfer request (e.g., a request receive $20 USD from a second user, a request for data from a second user). The transfer request may comprise a transfer amount, and an alias associated with a second user. The alias may be a digital tag, which uniquely identifies the second user across different transfer applications via a digital tag computer. In some embodiments, the digital tag may be a payment tag and the digital tag computer may be a payment tag service computer. The digital tag may be issued by an authorizing entity and registered with the digital tag computer to be used in transfers.

In an exemplary person-to-person funds transfer method, a first user may choose to send a payment to a second user for a good and/or service. The first user may choose one of a plurality of transfer applications (e.g., one of a plurality of digital wallets) to conduct the payment. The second user may receive the payment from the first user for the good and/or service. The second user may choose one of the plurality of transfer applications (e.g., one of a plurality of digital wallets) to receive the payment. The transfer application used by the first user may be different than the transfer application used by the second user.

A transaction such as this one can be streamlined by using a digital tag. In embodiments of the invention, one or more digital tags may be shared between the users. The one or more digital tags can link to one or more credentials (e.g., one or more payment credentials), which may be used to conduct the transaction. The use of the digital tag simplifies the transaction when the parties to the transaction use different transfer applications. When the parties to a transaction have different transfer applications, those transfer applications may not have a common way to communicate and transfer funds between them.

In some embodiments, a user such as a resource provider or an individual may request a digital tag. The digital tag may be requested from an authorizing entity associated with the user (e.g., issuer that maintains an account for the user). The digital tag may be linked to a previously issued credential, such as a payment credential issued by an authorizing entity.

It is desirable to ensure that the recipient of a funds transfer is the actual intended recipient. This is particularly true when the recipient or payee uses one transfer application on their user device, and the sender or payer uses a different transfer application on their user device. When the sender and the recipient use different transfer applications, the service providers operating the respective transfer applications may know and may not have verified the users associated with the other transfer applications that they do not operate or service. Embodiments of the invention address this and other problems.

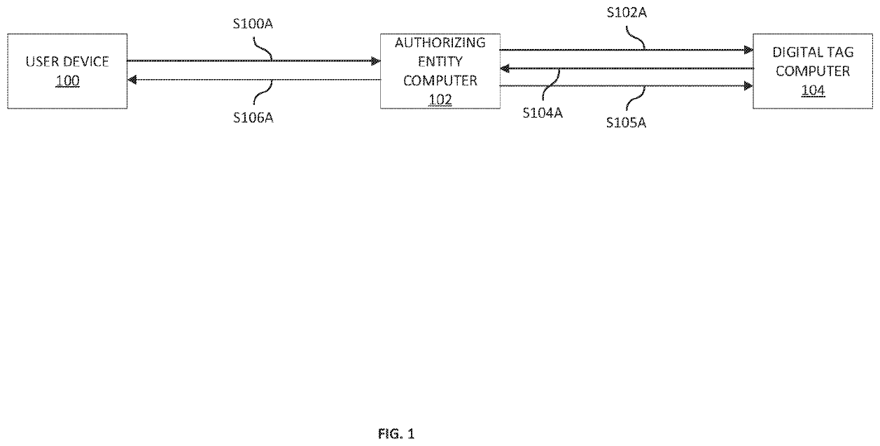

FIG. 1 shows a system comprising a user device 100, an authorizing entity computer 102, and a digital tag computer 104. These devices can be in operative communication with each other.

The components in the system of FIG. 1 and any of the following figures can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); and Secure Hypertext Transfer Protocol (HTTPS).

FIG. 1 shows an example flow for a user requesting an issuance of a digital tag from an authorizing entity computer 102. The user may be operating a user device 100. In some embodiments, the user device 100 may be a mobile phone. The user may be a resource provider or an individual.

In step S100A, the user device 100 may generate and transmit a request for a digital tag. The request may include a set of alphanumeric characters to be used as the digital tag, and information related to the user operating the user device 100 (e.g., an email address associated with the user, a phone number associated with the user, etc.). The request for a digital tag may then be transmitted to an authorizing entity computer 102 associated with the user. The authorizing entity computer 102 may maintain an account associated with the user which may be indicated by a primary account number.

In step S102A, after receiving the request for a digital tag from the user device 100, the authorizing entity computer 102 may verify the uniqueness of the requested digital tag. The authorizing entity computer 102 can communicate with a database maintained by a digital tag computer 104, which stores previously received requests (e.g., searching a database of digital tags to ensure that the requested digital tag does not overlap with plurality of digital tags stored). Although one authorizing entity computer 102 is shown as being in communication with the digital tag computer 104, there may be many authorizing entity computers in communication with the digital tag computer 104.

In step S104A, the authorizing entity computer 102 can receive a message from the digital tag computer 104 verifying the uniqueness of the digital tag. Then, the authorizing entity computer 102 may issue the digital tag by linking the digital tag to the primary account number of the user's account. In some embodiments, the digital tag may be linked to an alternative account identifier such as a payment token.

In step S105A, the issued digital tag and the primary account number, or alternative account identifier, may be transmitted to the digital tag computer 104 to be stored in a database. The user information (e.g., a phone number associated with the user) may also be transmitted to the digital tag computer 104 to be stored in the database linked to the digital tag along with the primary account number. The issued digital tag may be in any suitable format. For example, the issued digital tag may be a payment token, a data string comprising a username and authorizing entity identifier, a phone number, a label (e.g., QR code).

In step S106A, the authorizing entity computer 102 may transmit the issued digital tag to the user device 100.

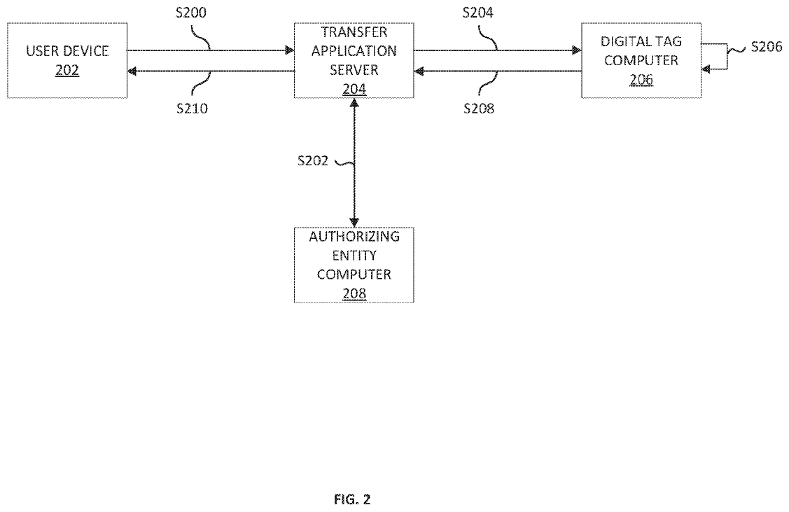

FIG. 2 shows an example system and flow for requesting issuance of a digital tag linked to a virtual credential from a transfer application server 204. The digital tag may be similar to the digital tag of FIG. 1. In FIG. 2, the user device 202 may be similar to the user device 101 in FIG. 1, the digital tag computer 206 may be similar to the digital tag computer 104 in FIG. 1, and the authorizing entity computer 208 may be similar to the authorizing entity compute 102 in FIG. 1. FIG. 2 also shows a transfer application server 204, which may support a transfer application on the user device 202.

The user device 202 may include a transfer application. The transfer application may be a digital wallet application, a peer-to-peer payment application, etc. The transfer application may be associated with the transfer application server 204 that facilitates the functions of the transfer application.

In step S200, the user device 202 may request a digital tag from the transfer application server 204 using the transfer application. The transfer application may be installed in the user device 202. The user may have an account with the transfer application and may request a digital tag using the user account. The request may include a set of alphanumeric characters to be used as the digital tag, and information related to the user account (e.g., an email address associated with the user, a phone number associated with the user account, etc.).

In step S202, upon receiving the request for the digital tag, the transfer application server 204 may issue a virtual credential that may link with the user account via an associated authorizing entity computer 208. The authorizing entity 208 may create and return the virtual credential to the transfer application server 204. The authorizing entity computer 208 may also maintain an account associated with the user which may be indicated by the virtual credential. The virtual credential may be in the form of a real payment credential, but unlike a real payment credential, it cannot be used to independently conduct payment transactions. The credential that will be issued can be a virtual receive only credential (i.e., a credential that only support incoming payments), or the credential can be a fully functional payment credential that can also be used in purchase transactions, AFTs, etc.

In step S204, the transfer application 204 may submit a request to a digital tag computer 206 to create a digital tag associated with the user. The request may comprise the digital tag chosen by the user in step S200, and the virtual credential issued by the authorizing entity 208 in step S202. Additionally, the request may contain the information related to the user account (e.g., a phone number associated with the user).

In step S206, the digital tag computer 206 may receive the request to create a digital tag. The digital tag computer 206 may retrieve the digital tag and the virtual credential from the request. Upon verifying the uniqueness of the digital tag from a database storing previously received requests (e.g., searching a database of digital tags to ensure that the requested digital tag does not overlap with plurality of digital tags stored), the digital tag computer 206 may tokenize the virtual credential. After tokenizing the virtual credential, the digital tag computer 206 may store the digital tag, the tokenized virtual credential, the virtual credential, and the user account information in the database. The digital tag computer 206 may also approve use of the digital tag.

In some embodiments, the virtual credential can be a receive only credential. This can be used to add a layer of security when the token is used by a payment originator to initiate an OCT message. If the token is compromised by a third-party, the third-party will be unable to pull funds from the underlying account.

In step S208, the digital tag computer 206 may confirm the approval of the digital tag with the transfer application server 204.

In step S210, the transfer application server 204 may notify the transfer application of the user device 202 the digital tag was approved and is available for use. The virtual credential linked to the digital tag may point to the user account managed by the transfer application server 204. In some embodiments, the digital tag may be linked to both the virtual credential and the user account of the transfer application server 204.

The digital tag linked to a virtual credential may be used in a peer-to-peer transaction. For example, a first user using a first transfer application may send, receive, or request a transaction with a second user using a second transfer application. The digital tag allows for the transaction to be initiated with the digital tag of the second user which will then be resolved into a virtual credential that links to an account managed by the transfer applications of the second user.

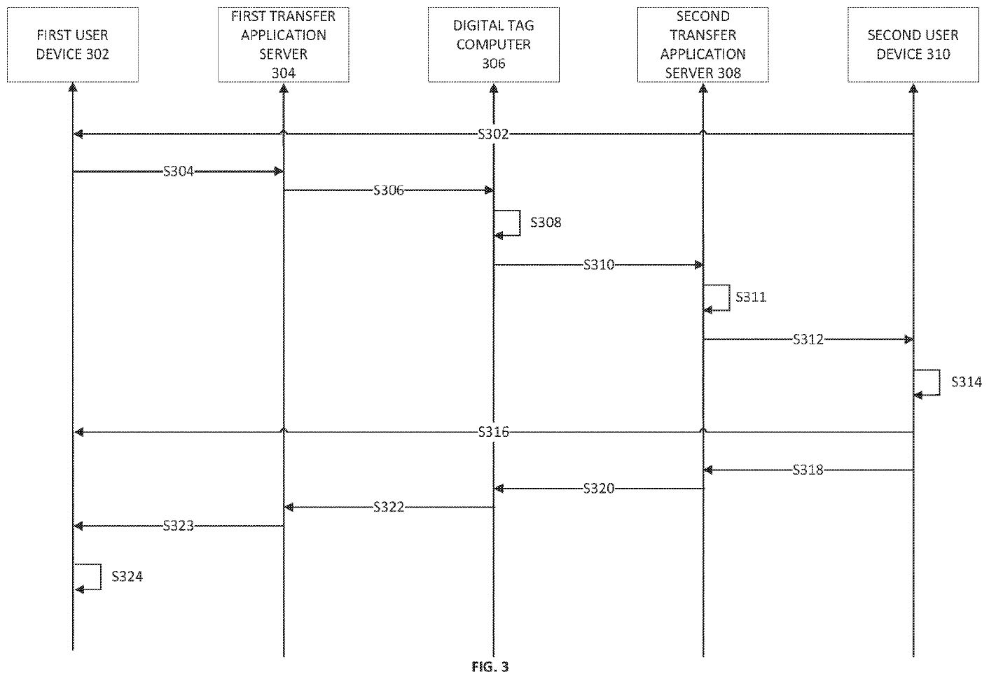

FIG. 3 shows a system and a flow diagram of a user verification process where a first user device 302 and a second user device 310 are remote from each other. A digital tag computer may reside between (in an operational sense) the first user device 302 and the second user device 310. The first user device 302 may have a first transfer application, which may communicate with a first transfer application server 304. The second user device 310 may have a second transfer application, which may communicate with a second transfer application server 308. The first transfer application may be different than the second transfer application. For example, the first transfer application may be a first wallet application, and the second transfer application may be a different, second wallet application. A user of the first user device 302 may be a first user that sends a payment, and a user of the second user device 310 may be a second user that receives the payment.

In this example, the first user device 302 and the second user device 310 may each have a digital tag linked to a virtual credential, which may be linked to a user account of a transfer application. Each user device may use the digital tag for peer-to-peer transactions. The issuance of a digital tag linked to a virtual credential is further described in FIG. 2.

In step S302, the second user may send a digital tag (e.g., “amiller.wallet1”) associated with the second user, to the first user. The second user may send the digital tag to the first user in any suitable manner. For example, the second user may use the second user device 310 to send the digital tag to the first user device 302 via a text message, e-mail, chat message, or any other form of communication. In some embodiments, the second user device 310 may display a label (e.g., a QR code) comprising the digital tag for the first user device 302 to scan. In other embodiments, the second user of the second user device 310 may share the digital tag verbally, via NFC, Bluetooth, ultrasound, e-mail, etc.

In step S304, the first user may open a first transfer application of the first user device 302 (e.g., a digital wallet application, a peer-to-peer application, etc.) for a transfer transaction. The first user may enter the digital tag associated with the second user and a transaction amount in the first transfer application. In some embodiments, the first user may enter additional information (e.g., a transaction memo) into the first transfer application. The first transfer application of the first user device 302 may then send a digital tag associated with the first user (e.g., “jsmith.wallet2”), the digital tag associated with the second user, and the transaction amount to the first transfer application server 304.

The digital tag associated with the first user may be referred to as a first digital tag, and the digital tag associated with the second user may be referred to a second digital tag.

In step S306, the first transfer application server 304 may generate a transfer request message for the transfer transaction comprising at least the first digital tag, the second digital tag, and the transaction amount. The first transfer application server 304 may then send the transfer request message to the digital tag computer 306.

In step S308, responsive to receiving the transfer request message, the digital tag computer 306 may determine whether the second digital tag exists in its database. If the second digital tag exists, then the digital tag computer 306 may obtain stored user information such as a credential (e.g., a virtual credential or a real credential), a device identifier (e.g., a mobile phone number), etc. that may be associated with the second digital tag. The credential may be linked to the second user's account of the second transfer application server 308, and the device identifier may be a device identifier of the second user device 310.

The digital tag computer 306 may also generate a random number after receiving the transfer request message. The random number may be used to form a code and can help prevent a man-in-the-middle attack, since it is only known to the digital tag computer 306. The random number also provides randomness to the generated code since a new code is generated for each transaction and old codes cannot be replayed. The random number may be generated using a random number generator in the digital tag computer 306.

The digital tag computer 306 may then determine a code that is derived from one or more of the following: at least a portion of the credential, at least a portion of the device identifier, and/or at least a portion of the transaction amount; and the random number. For example, the digital tag computer may generate a code such as “8293” which may be derived from the last four digits of a primary account number (PAN) associated with the second digital tag of the recipient, the last four digits of the recipient's mobile number, the last four digits of the transaction amount, and the random number. The generation of the code may occur in any suitable manner using any suitable algorithm. For example, the last four digits of a primary account number (PAN) associated with the second digital tag of the recipient, the last four digits of the recipient's mobile number, the last four digits of the transaction amount, and the random number can be encrypted with a cryptographic key, and then the result can be truncated to four digits.

In some embodiments, the digital tag computer 306 may provide data including at least a portion of the credential (e.g., the last four digits of the credential or the full credential), at least a portion of the device identifier (the recipient's phone number), at least a portion of the transaction amount (e.g., the entire transaction amount), the second digital tag, and the code to the second transfer application server 308, and possibly the second user device 310. In some embodiments, the second transfer application server 308 can receive a full credential and it can identify the second user based on the credential vs. using the second user tag. In some cases, this data may be included in a digital certificate, which also includes a digital signature of the digital tag computer 306. In some embodiments, the digital tag computer 306 may form the digital signature by hashing (e.g., using a hashing algorithm such as SHA-256) a concatenated value of the at least the portion of the credential (e.g., the last four digits of the credential), the at least the portion of the device identifier (the recipient's phone number), the at least the portion of the transaction amount (e.g., the entire transaction amount), the second digital tag, and the code, hashing the concatenated value, and then signing the hash using a private key of the digital tag computer 306. An asymmetric cryptographic algorithm (such as RSA, Diffie-Hellman, El Gamal, etc.) can be used in the signing process.

In step S310, the digital tag computer 306 may then transmit the digital certificate including the at least the portion of the credential, at least the portion of the device identifier, the second digital tag, the transaction amount, the public key of the digital tag computer 306, the code, and the digital signature to the second transfer application server 308.

In step S311, the second transfer application server 308 may verify the information in the digital certificate. In some embodiments, the second transfer application server 308 may use the public key of the digital tag computer 306 to verify the digital signature according to known public key verification methods.

The second transfer application server 308 may check whether the second digital tag exists in its database. If the second digital tag exists, the second transfer application server 308 may use the second digital tag to obtain a credential (e.g., a virtual credential) linked to the digital tag, and obtain user account information (e.g., a device identifier) associated with the credential from its database. In other embodiments, the second transfer application server 308 can obtain user information based on the credential instead of using the second digital tag. The second transfer application server 308 may compare the credential and the device identifier retrieved from its database to the at least the portion of the credential and the at least the portion of the device identifier received from the digital tag computer 306. If the information matches, then the transfer may be considered valid.

In step S312, the second transfer application server 308 may send a notification message to the second user application of the second user device 210 to notify the second user that a payment is waiting for the second user. The notification message may also include the first digital tag and the transaction amount. For example, if the first digital tag is “jsmith.wallet2” and the transaction amount of “$100,” the second transfer application server 308 may send a notification message such as “jsmith.wallet2 is trying to send $100 to you” to the second transfer application on the second user device 310. The notification message may also display the code generated by the digital tag computer 306, or it may display it after the second user authenticates herself to the second authentication application on the second user device 310.

In step S314, the second user may open the second user application of the second user device 310 and may perform an authentication process (e.g., entering biometric information, password, etc. into the second transfer application) to log into the second transfer application. In some embodiments, the second transfer application may use two-factor authentication to authenticate the second user. After authenticating with the second transfer application on the second user device 310, the second user may review the presented information, and may confirm that she wishes to receive the payment of the transaction amount from the first user associated with the first digital tag using the second user application. Upon the confirmation, the code may be provided to the second user (e.g., by displaying the code on the second user device screen).

In step S316, the second user device 310 may share the code to the first user device 302. The second user device 310 may send the code to the first user device 302 by using a text message, e-mail, in person, etc. etc.

In step S318, the second user device 310 may send a confirmation to the second transfer application server 308 that the second user wants to proceed with the transaction, and has verified the information that was provided to the second user device in step S312.

In step S320, the second transfer application server 308 may send a confirmation message indicating that the second user wants to conduct the transfer transaction and the information of the digital certificate including the at least the portion of the credential, the at least the portion of the device identifier, and the second digital tag were verified by the second user to the digital tag computer 306. The confirmation message may also include information indicating that the second user has shared the code with the first user.

In steps S322 and S323, upon receiving the confirmation message, the digital tag computer 306 may send the code to the first user device 302 via the first transfer application server 304. The digital tag computer 306 can send the code to the first user device 302 via the first transfer application server 304 such that the code from the confirmation message would not be displayed to the first user of the first user device 302. The code received by the first user device 302 would reside in a memory in the first user device 302.

In step S324, the first user may enter the code received from the second user device 310 in step S316 into the first transfer application of the first user device 302. The first transfer application compares the code received from the second user device 310 with the code sent by the digital tag computer 306. If the codes match, then the first user can be assured that the money will be sent to the correct second user.

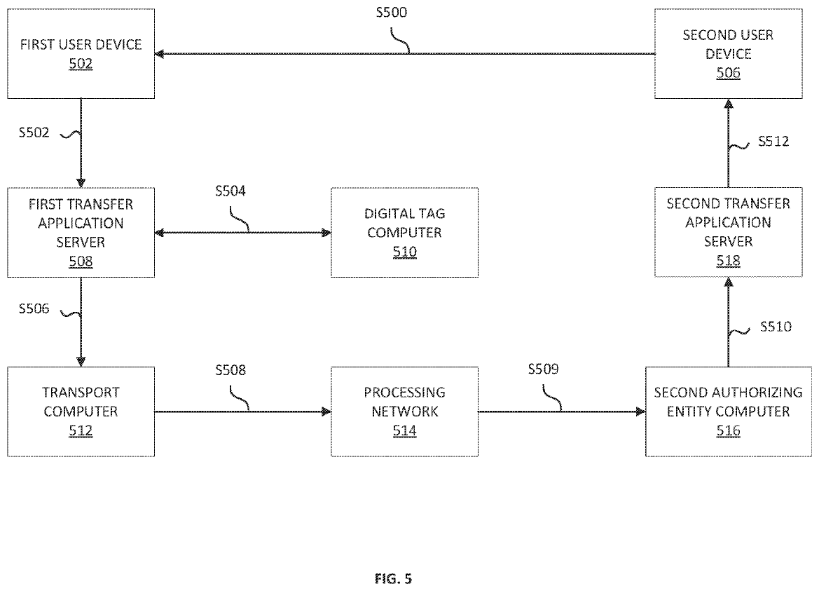

Once the second user is verified, the first transfer application of the first user device 302 can then initiate a transfer transaction associated with the second user. The transfer application of the first user device 302 may initiate the transfer transaction by transmitting a push transfer message to a transport computer. There may also be a time limit where the transfer transaction will not be processed if a certain amount of time has elapsed. Further descriptions regarding transfer transactions are provided below with reference to FIG. 5.

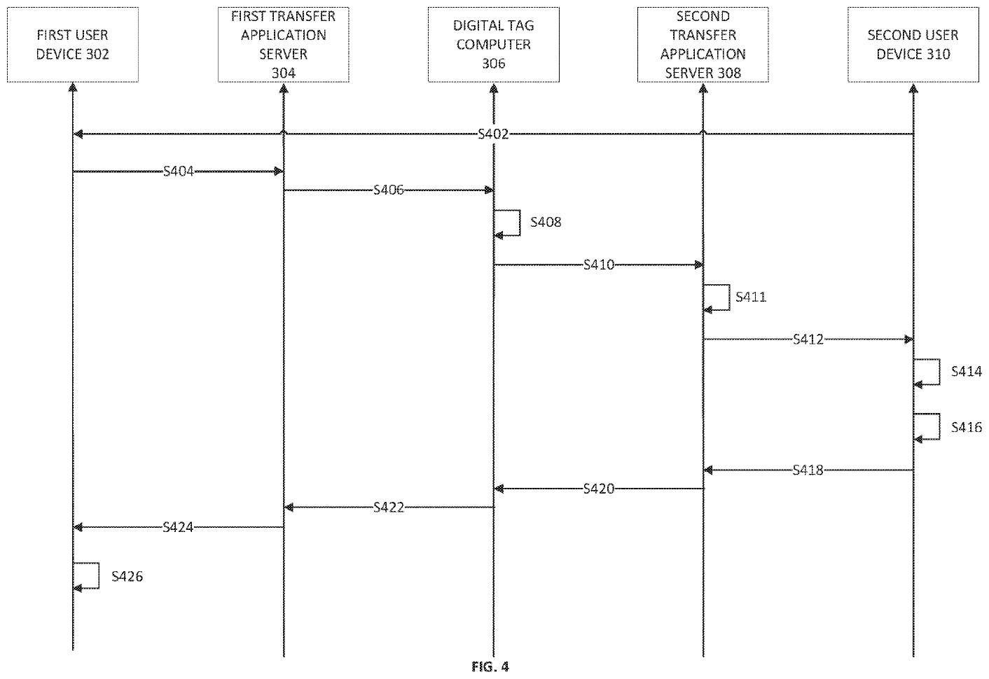

FIG. 4 shows a system and a flow diagram of a user verification process where a first user device 302 and a second user device 310 are proximate to each other.

Steps S402 to S414 may be similar to steps S302 to S314 of FIG. 3 and the descriptions of these steps will not be repeated here.

In step S416, the second transfer application of the second user device 310 may be given an option to generate a QR code with the code and the first user's tag embedded into the QR code. The second user may select the option to generate the QR code, and may use the second user device 310 to display the QR code on a screen such that the first user of the first user device 302 may scan the QR code and obtain the embedded code. In some embodiments, the second user of the second user device 310 can share the digital tag verbally, Bluetooth, etc.

In step S418, the second user device 310 may send a confirmation to the second transfer application server 308 that the second user wants to proceed with the transaction, and has verified the information that was provided to the second user device in step S412.

In step S420, the second transfer application server 308 may send a confirmation message indicating that the second user wants to conduct the transfer transaction and the information of the digital certificate including the at least the portion of the credential, the at least the portion of the device identifier, and the second digital tag were verified by the second user to the digital tag computer 306. The confirmation message may also include information indicating that the second user has shared the code with the first user.

In steps S422 and S424, upon receiving the confirmation message, the digital tag computer 306 may send the code to the first user device 302 via the first transfer application server 304. The digital tag computer 306 can send the code to the first user device 302 via the first transfer application server 304 such that the code from the confirmation message would not be displayed to the first user of the first user device 302. The code received by the first user device 302 would reside in a memory in the first user device 302.

In step S426, the first user may open the first transfer application. The first user then may use the first user device 302 to scan the QR code displayed on the screen of the second user device 310. The code embedded in the QR code may then be transferred to the first transfer application, and the first transfer application may compare the code from the digital tag computer 306 with the code embedded in the QR code. If the codes match, then the first user can be assured that the funds will be sent to the correct second user.

Once the second user is verified, the first transfer application of the first user device 302 can then initiate a transfer transaction associated with the second user. The transfer application of the first user device 302 may initiate the transfer transaction by transmitting a push transfer message to a transport computer. There may also be a time limit where the transfer transaction will not be processed if a certain amount of time has elapsed. Further descriptions regarding transfer transactions are provided below with reference to FIG. 5.

FIG. 5 shows an example flow for a transaction between a first user and a second user using a digital tag linked to a virtual credential. The first user operating a first user device 502 may conduct a transaction (e.g., sending a payment) using a first transfer application in the first user device 502. The second user operating a second user device 506 may receive the payment using a second transfer application in the second user device 506.

The first transfer application and the second transfer application may be a digital wallet application, a peer-to-peer payment application, etc. The first transfer application may be associated with a first transfer application server 508 that facilitates the functions of the first transfer application. The second transfer application may be associated with a second transfer application server 518 that facilitates the functions of the second transfer application.

The first transfer application server 508 can be in communication with a digital tag computer 510. The first transfer application server 508 may also be in operative communication with a second authorizing entity computer 516 associated with the second user of the second user device 506, via a transport computer 512 and a processing network 514. The second authorizing entity computer 516 may also maintain an account associated with the second user which may be indicated by the virtual credential. A first authorizing entity computer (not shown) may hold an account of the first user of the first user device 502 and may be in communication with the transport computer 512.

In step S500, the second user device 506 may share their digital tag with the first user device 502. In some embodiments, the second user device 506 may display a label (e.g., a QR code) comprising the digital tag for the first user device 502 to scan. In other embodiments, the second user of the second user device 506 can share the digital tag verbally, via NFC, Bluetooth, ultrasound, e-mail, etc.

In step S502, the first user device 502 may use the first transfer application stored in the first user device 502 to route the digital tag to a first transfer application server 508. In some embodiments, the first user device 502 may enter the received digital tag and an amount of the transaction to be sent to the second user into the first transfer application. The first user device 502 may send the entered information to the first transfer application server 508. In other embodiments, in step 500, the digital tag may be received directly by the first transfer application server 508.

In step S504, the first transfer application server 508 may send the digital tag to a digital tag computer 510 to resolve the digital tag into a credential linked to the second user device 506. The digital tag computer 510 may then retrieve the credential (e.g., the virtual credential or the tokenized virtual credential stored by the digital tag computer 106 in step S206 of FIG. 2) from a database and return the credential to the first transfer application server 508.

In step S506, after receiving the credential from the digital tag computer 510, the first transfer application server 508, in conjunction with a transport computer 512, may generate a push transfer message. In some embodiments, the push transfer message may be an original credit transaction message using the virtual credential received. The message may comprise the amount of the transaction, an account identifier (or token) associated with the first user device 502, and the credential linked to the second user device 506. The message may be sent to a second authorizing entity computer 516 via a processing network 514

In some embodiments, the push transfer message may be an OCT (Original Credit Transaction) message. An OCT (Original Credit Transaction) can be a clearing and settlement credit transaction designed for use in business applications such as a business money transfer or business-to-consumer repayments. The OCT can be a transaction used to deliver funds to the recipient account. It is separate from, and can take place after, an AFT transaction in some cases. This timing is to ensure that payment funds are secured before funds are sent to the recipient.

In steps S508 and S509, after receiving the push transfer message from the first transfer application server 508, the transport computer 512 may route the push transfer message to a second authorizing entity computer 516 via a processing network 514.

In step S510, the second transfer application server 418 may receive the payment and deposit the funds into the account associated with virtual credential, or a real credential associated with the virtual credential. Alternatively, the second authorizing entity computer 516 could deposit the funds into the account associated with virtual credential, or a real credential associated with the virtual credential. The second authorizing entity computer 516 may have previously issued the virtual credential based on the real credential associated with the second user.

In step S512, the second transfer application server 518 may notify the second transfer application of the second user device 506 on the received payment. The second transfer application may display a notification to the second user on the completion of the transaction.

At a later time, actual funds may be transferred from the first authorizing entity operating the first authorizing entity computer (not shown) coupled to the transport computer 512 to the second authorizing entity computer 516 via the processing network 314 in a settlement process.

The above embodiment allows for a first user using a first transfer application to transact with a second user using any other (or the same) transfer application. A first user may be able to send, receive, and request transactions from a second user, as the digital tag is resolved by a digital tag computer into the virtual credential. The transfer applications may have a communication channel with the digital tag computer to retrieve the virtual credential. The virtual credential may then be used to initiate a transaction. The first user and second user can share their respective digital tags to any other user without the need to share their real credential as the digital tag (along with the digital tag computer) contain all necessary routing information needed to complete a transaction (e.g., a user's credential is linked to their digital tag which is resolved by the digital tag computer for use in a transaction).

Other digital tag payment processes can be found in PCT/US2021/030145, filed on Apr. 30, 2021, which is herein incorporated by reference in its entirety.

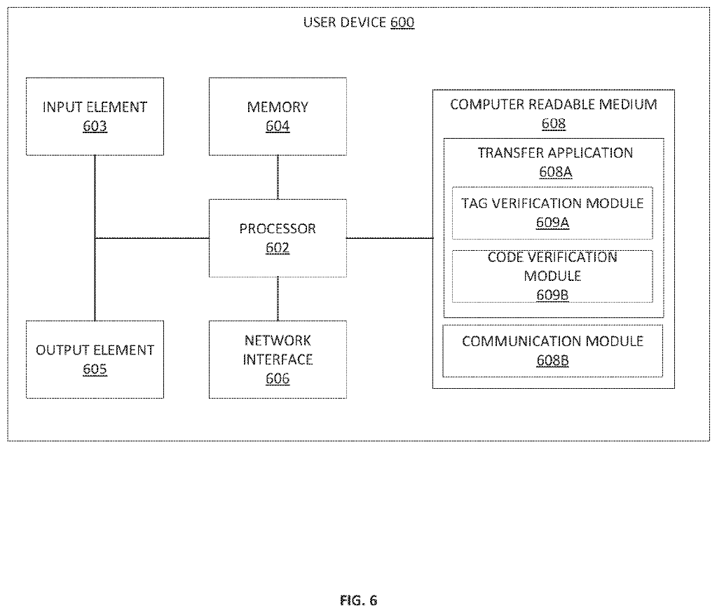

FIG. 6 shows a block diagram of a user device 600 according to embodiments. The user device 600 may comprise a processor 602. The processor 602 may be coupled to an input element 603, an output element 605, a memory 604, a network interface 606, and a computer readable medium 608. The computer readable medium 608 may comprise any suitable number and types of software modules.

Examples of input elements may include microphones, keypads, touchscreens, sensors, etc. Examples of output elements may include speakers, display screens, and tactile devices. The processor 602 can be implemented as one or more integrated circuits (e.g., one or more single core or multicore microprocessors and/or microcontrollers) and can be used to control the operation of the user device 600. The processor 606 can execute a variety of programs in response to program code or computer-readable code and can maintain multiple concurrently executing programs or processes

The memory 604 may be used to store data and code. The memory 604 may be coupled to the processor 602 internally or externally (e.g., via cloud-based data storage), and may comprise any combination of volatile and/or non-volatile memory such as RAM, DRAM, ROM, flash, or any other suitable memory device. In some embodiments, the memory 604 may store the data items of a payload.

The network interface 606 may include an interface that can allow the user device 600 to communicate with external computers. The network interface 606 may enable the user device 600 to communicate data to and from another device such as an aggregation entity computer, a digital tag computer, a transport computer, an authorizing entity computer, etc. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 606 may include Wi-Fi™. Data transferred via the network interface 606 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 608 may comprise code, executable by the processor 602, for a method comprising: entering, into a first transfer application on a first user device, a digital tag associated with a second user and a transaction amount; transmitting, by the first transfer application to a digital tag computer, the digital tag associated with the second user and the transaction amount, wherein the digital tag computer generates a code and sends the code to a second transfer application associated with the second user; receiving, by the first transfer application from the digital tag computer, the code; receiving, by the first transfer application, the code from the second user; determining that the code received from the digital tag computer and the code received from the second user match; and responsive to the match, processing a transfer of the transaction amount to the second transfer application associated with the second user.

The computer readable medium 608 may comprise several software modules including, but not limited to, a transfer application 608A, and a communication module 608B.

The transfer application 608A may comprise a tag verification module 609A and a code verification module 609B, executable by the processor 602. The tag verification module 609A can communicate with a transfer application server to verify information sent by a digital tag computer 700. For example, a user device 600 may receive a digital certificate from the digital tag computer 700. The user device 600 may use the tag verification module 609A to verify information in the digital certificate such as a digital tag, a portion of a credential, and a portion of a device identifier. The code verification module 609B can communicate with a transfer application server to verify the code received by another user device and a digital tag computer. For example, a user device may receive a first code from another user device and a second code from the digital tag computer. The user device may use the code verification module 609B to check whether the first code matches with the second code.

The communication module 608B may comprise code that causes the processor 602 to generate messages, forward messages, receive message, reformat messages, and/or otherwise communicate with other entities. In some embodiments, the communication module 608B may facilitate push transfer message and/or a pull transfer message being transmitted to a transport computer.

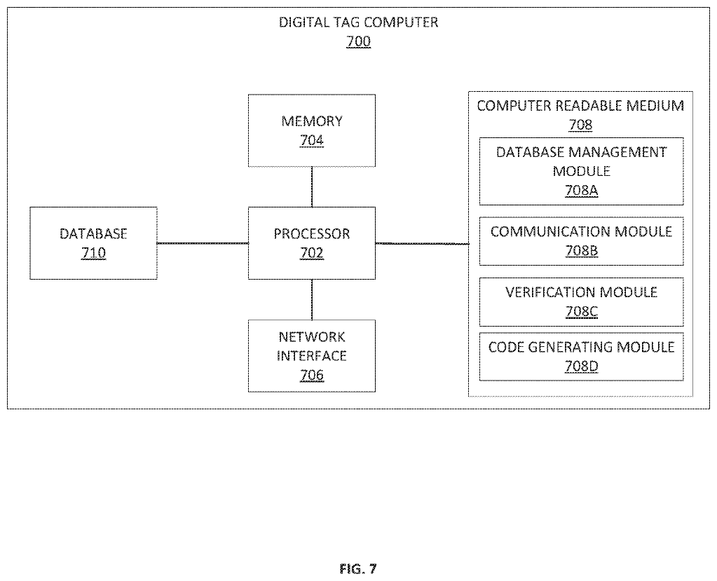

FIG. 7 shows a block diagram of a digital tag computer 700 according to embodiments. The digital tag computer 700 may facilitate the use of a digital tag. For example, the digital tag computer 700 may resolve a digital tag to an account identifier that was linked during the registration of the digital tag. The digital tag computer 700 may store a plurality of digital tags. The digital tag computer 700 may comprise a processor 702. The processor 702 may be coupled to a memory 704, a network interface 706, a computer readable medium 708, and a database 710. The computer readable medium 708 may comprise any suitable number and types of software modules.

The memory 704 can be used to store data and code. In some embodiments, the memory 704 may be linked to a database 710. The memory 704 and/or the database 710 may be coupled to the processor 702 internally or externally (e.g., via cloud-based data storage), and may comprise any combination of volatile and/or non-volatile memory such as RAM, DRAM, ROM, flash, or any other suitable memory device. The database 710 may comprise a directory for the link between a digital tag and an account identifier. In some embodiments, the digital tag computer 700 may store the data items (e.g., a digital tag, the account identifier and/or token, etc.) received as a result of issuing a digital tag in the database 710.

The network interface 706 may include an interface that can allow the digital tag computer 700 to communicate with external computers. The network interface 706 may have the same features or different features as the previously described network interface 606.

The computer readable medium 708 may comprise code, executable by the processor 702, for a method comprising: receiving, by a digital tag computer from a first transfer application on a first user device, a transfer request message for a transfer transaction, the transfer request message comprising a digital tag associated with a second user and a transaction amount; responsive to receiving the transfer request message, generating, by the digital tag computer, a code; transmitting, by the digital tag computer, the code to a second transfer application associated with the second user, the second application on a second user device; receiving, by the digital tag computer, a confirmation message that the second user wants to conduct the transfer transaction and is sharing the code with the first user; and responsive to receiving the confirmation message, transmitting, by the digital tag computer, the code to the first transfer application on the first user device, wherein first transfer application on the first user device compares the code received from the digital tag computer with the code received from the second user, and initiates the transfer transaction if the code received from the digital tag computer with the code received from the second user matches.

The computer readable medium 708 may comprise several software modules including, but not limited to, a database management module 708A, a communication module 708B, a verification module 708C, and a code generating module 708D.

The database management module 708A may comprise code that causes the processor 702 to manage data stored by the memory 702 and/or the database 710. For example, during issuance of a digital tag, the database management module 708A may allow the processor 702 to verify the uniqueness of a received digital tag to a plurality of digital tags stored in the database 710. In some embodiments, after the digital tag computer 700 receives a payload, the database management module 708A may retrieve the account identifier or token linked to an issued digital tag included in the payload.

The communication module 708B may comprise code that causes the processor 702 to generate messages, forward messages, receive message, reformat messages, and/or otherwise communicate with other entities. For example, the communication module 708B may allow the processor 702 to receive a request to check the uniqueness of a digital tag from an authorizing entity computer or a user device and generate a response.

The verification module 708C may comprise code that causes the processor 702 to verify whether the digital tag received from a user device 600 exist in its database. For example, a first user device can send a digital tag of a second user device to conduct a transfer transaction (e.g., sending money). The digital tag computer 700 can use the verification module 708C to verify whether the digital tag of a second user device exists in the database 710. The verification module 708C can also obtain other data stored in the database 710 that links to the digital tag, such as a credential (e.g., a primary account number), a device identifier number (e.g., a mobile phone number), etc.

The code generating module 708D may comprise code that causes the processor 702 to generate a code. The code can be generated by using the data obtained in verification module 708C and a random number. For example, a portion of the credential, a portion of a mobile phone number, transaction amount, and the random number can be used to generate a code.

Embodiments of the invention have many technical and security advantages. As noted above, the code that can generated using embodiments of the invention is formed from several data elements specific to a recipient of a funds transfer. The code may also be formed from a random number for each transaction thereby preventing replay attacks using old codes. Because the code is different for every transaction and is tied to the specific recipient and the specific transfer being conducted, the code is unique and secure. The recipient's verification of the information used to generate the code can provide assurance to the sender of any transfers that any transferred funds will be send to the correct recipient. Also, the recipient can also verify the digital signature of the digital tag computer when confirming the correctness of data from the digital tag computer, thus providing assurance to the second user and the second user device that the transaction that is to be conducted is legitimate. Still further, the digital tags that are used in embodiments of the invention can protect the underlying account credentials from man-in-the-middle attacks, further improving data security.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a digital tag computer from a first transfer application on a first user device associated with a first user, a transfer request message for a transfer transaction, the transfer request message comprising a digital tag associated with a second user and a transaction amount;
responsive to receiving the transfer request message, generating, by the digital tag computer, a code;
transmitting, by the digital tag computer, the code to a second transfer application associated with the second user, the second transfer application on a second user device;
receiving, by the digital tag computer, a confirmation message that the second user wants to conduct the transfer transaction and is sharing the code with the first user; and
responsive to receiving the confirmation message, transmitting, by the digital tag computer, the code to the first transfer application on the first user device, wherein first transfer application on the first user device compares the code received from the digital tag computer with the code received from the second user, and initiates the transfer transaction if the code received from the digital tag computer with the code received from the second user match.

2. The method of claim 1, wherein the code is formed from a random number.

3. The method of claim 1, wherein the code is in a digital certificate when the code is transmitted from the digital tag computer to the second transfer application.

4. The method of claim 1, wherein the code is in a digital certificate when the code is transmitted from the digital tag computer to the second transfer application, and the digital certificate further comprises: a portion of a credential; the digital tag, a device identifier for the second user device, and the transaction amount.

5. The method of claim 1, wherein the code is in a digital certificate when the code is transmitted from the digital tag computer to the second transfer application, and the digital certificate further comprises: a portion of a credential; the digital tag, a device identifier for the second user device, and the transaction amount and a digital signature.

6. The method of claim 5, wherein the digital signature is formed by signing a hash of a concatenated value comprising at least the portion of a credential; the digital tag, the device identifier for the second user device, and the transaction amount using a digital tag computer private key.

7. The method of claim 6, wherein the second user device verifies the digital signature using a digital tag computer public key.

8. The method of claim 1, further comprising:
determining, by the digital tag computer, if the digital tag is stored in a database at the digital tag computer.

9. The method of claim 8, further comprising:
after determining that the digital tag is stored in the database, retrieving at least a portion of a credential and device identifier from the database.

10. The method of claim 9, further comprising:
transmitting, by the digital tag computer, a digital certificate comprising the at least the portion of the credential, the digital tag, the device identifier for the second user device, and the transaction amount and a digital signature to the second user device.

11. The method of claim 10, wherein the device identifier is a phone number.

12. The method of claim 1, wherein the transfer request message is received from the first transfer application via a first transfer application server, and the code is transmitted to the second user device to the second transfer application via a second application server.

13. The method of claim 1, wherein the code is generated using at least a portion of a credential, a device identifier for the second user device, the transaction amount, and a random number.

14. The method of claim 1, wherein the first user device initiates the transfer transaction if the code received from the digital tag computer with the code received from the second user match, the first user device initiating the transfer transaction by initiating a push transfer message with a transport computer.

15. The method of claim 14, wherein the push transfer message is an OCT message.

16. A digital tag computer comprising:
a processor; and
a non-transitory computer readable medium, the non-transitory computer readable medium comprising code, executable by the processor to perform operations comprising:
receiving, from a first transfer application on a first user device associated with a first user, a transfer request message for a transfer transaction, the transfer request message comprising a digital tag associated with a second user and a transaction amount;
responsive to receiving the transfer request message, generating a code;
transmitting the code to a second transfer application associated with the second user, the second transfer application on a second user device;
receiving a confirmation message that the second user wants to conduct the transfer transaction and is sharing the code with the first user; and
responsive to receiving the confirmation message, transmitting the code to the first transfer application on the first user device, wherein first transfer application on the first user device compares the code received from the digital tag computer with the code received from the second user, and initiates the transfer transaction if the code received from the digital tag computer with the code received from the second user match

17. A method comprising:
entering, into a first transfer application on a first user device, a digital tag associated with a second user and a transaction amount;
transmitting, by the first transfer application to a digital tag computer, the digital tag associated with the second user and the transaction amount, wherein the digital tag computer generates a code and sends the code to a second transfer application on a second user device associated with the second user;
receiving, by the first transfer application from the digital tag computer, the code;
receiving, by the first transfer application, the code sent from the second user;
determining that the code received from the digital tag computer and the code received from the second user match; and
responsive to the match, processing a transfer of the transaction amount to the second transfer application associated with the second user

18. The method of claim 17, wherein the code is received by the first transfer application from the second user via the second user device associated with the second user, the second user device storing the second transfer application.

19. The method of claim 17, wherein the code is generated using a random number generated by the digital tag computer.

20. The method of claim 17, wherein the code is derived from two or more of at least a portion of a credential, a device identifier for the second user device, the transaction amount, or a random number.
